(19) United States
(12) Patent Application Publication
(10) Pub. No.: US 2020/0372518 A1
(43) Pub. Date: Nov. 26, 2020

(54) METHOD AND DEVICE FOR DETERMINING NUMBER OF SOFTWARE LICENSES

(71) Applicant: Quanta Computer Inc., Taoyuan City (TW)

(72) Inventors: Chen-Chung LEE, Taoyuan City (TW); Chia-Hung LIN, Taoyuan City (TW); Hung-Yu YANG, Taoyuan City (TW); Ming-Jen CHEN, Taoyuan City (TW)

(21) Appl. No.: 16/658,321

(22) Filed: Oct. 21, 2019

(30) Foreign Application Priority Data
May 24, 2019 (TW) 108117944

(51) Int. Cl. G06Q 30/00; G06Q 10/10

(52) U.S. Cl. CPC G06Q 30/018; G06Q 10/1091

(57) ABSTRACT

A method for determining a number of software licenses is provided. The method is used in an electronic device and includes: obtaining the number of software license and a full utilization rate of the software in a preset period; obtaining a number of employee who works overtime, a number of overtime hours, amount of time spent using the software, and the cost related to the overtime in the preset period; computing an opportunity cost based on the number of employee who works overtime, the number of overtime hours, the amount of time spent using the software and the cost related to the overtime; determining an expected increase in number of the software licenses according to the opportunity cost and the full utilization rate.

### CROSS REFERENCE TO RELATED APPLICATIONS

This application claims priority of Taiwan Patent Application No. 108117944, filed on May 24, 2019, the disclosure of which is incorporated by reference herein in its entirety.

### TECHNICAL FIELD

The disclosure relates to a method and a device for determining the number of software licenses. More specifically, the present disclosure relates to a method and a device for determining the number of software licenses based on the actual status of using the software.

### BACKGROUND

There is always a problem with how many software licenses are sufficient. Too many software licenses can result in an increase in authorized purchase and maintenance costs. Too few software licenses can result in increased labor costs in overtime and the cost of idle employees, and increase the risk of illegal authorization.

Therefore, how to provide a decision-making mechanism to evaluate and measure these factors and find the optimal number of software licenses is an important issue in software licensing.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

A method and a device for determining a number of software licenses are provided in the disclosure.

In an embodiment, a method for determining a number of software licenses is provided in the disclosure. The method is used in an electronic device and comprises: obtaining the number of software licenses and a full utilization rate of the software in a preset period; obtaining a number of employees who work overtime, a number of overtime hours, amount of time spent using the software, and cost related to the overtime in the preset period; computing opportunity cost based on the number of employees who work overtime, the number of overtime hours, the amount of time spent using the software and the cost related to the overtime; and determining an expected increase in number of the software licenses according to the opportunity cost and the full utilization rate.

In some embodiments, the method further comprises: obtaining authorization cost and an amortization period for the software; and determining the expected increase in number of the software licenses according to the opportunity cost, the authorization cost, the amortization period and the full utilization rate.

In some embodiments, the number of software licenses, the full utilization rate, the number of employees who work overtime, the number of overtime hours, the amount of time spent using the software, and the cost related to the overtime in the preset period are obtained from a storage device.

In some embodiments, the preset period is one month or one year.

In an embodiment, a device for determining a number of software licenses is provided. The device comprises a control circuit, a processor and a memory. The processor is installed in the control circuit. The memory is installed in the control circuit and operatively coupled to the processor. The processor is configured to execute program codes stored in the memory to: obtain the number of software licenses and a full utilization rate of the software in a preset period; obtain a number of employees who work overtime, a number of overtime hours, amount of time spent using the software, and cost related to the overtime in the preset period; compute opportunity cost based on the number of employees who work overtime, the number of overtime hours, the amount of time spent using the software, and the cost related to the overtime; and determine an expected increase in number of the software licenses according to the opportunity cost and the full utilization rate.

### BRIEF DESCRIPTION OF DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to the size in actual implementation in order to clearly illustrate the concept of the present disclosure.

FIG. 1 is a schematic diagram of a system for determining the number of software licenses according to an embodiment of the present disclosure.

FIG. 2 shows an alternative simplified functional block diagram of a communication device according to one embodiment of the present disclosure.

FIG. 3 is a flowchart illustrating a method for determining the number of software licenses in accordance with an embodiment of the present disclosure.

FIG. 4 is a table illustrating the number of employees who work overtime, the number of overtime hours, the amount of time spent using the software on weekdays in December according to an embodiment of the present disclosure.

FIG. 5 is a table illustrating the opportunity cost in accordance with an embodiment of the present disclosure.

FIGS. 6A-6C illustrate an analysis table of the number and cost of the software according to an embodiment of the present disclosure.

FIG. 7 is a diagram illustrating the purchasing cost of the software and the cost related to the overtime according to an embodiment of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

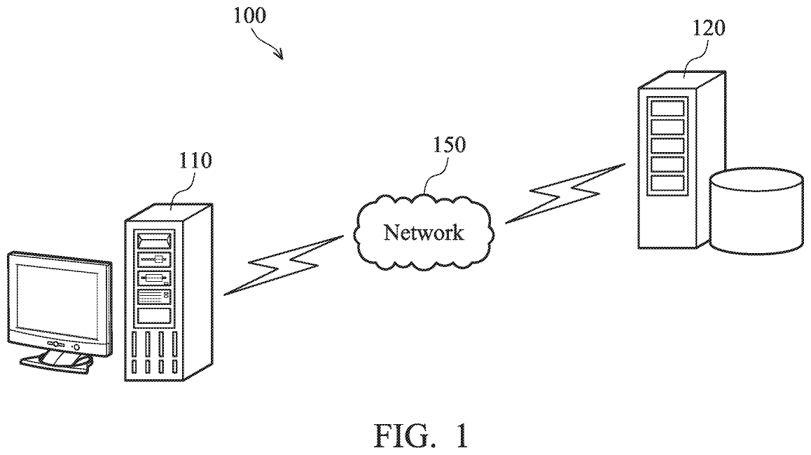

FIG. 1 is a schematic diagram of a system 100 for determining the number of software licenses according to an embodiment of the present disclosure. The system 100 may comprise an electronic device 110, a storage device 120 and a network 150. The electronic device 110 may be connected to the storage device 120 via the network 150. The types of electronic device range from small handheld devices, such as mobile telephones and handheld computers to large mainframe systems, such as mainframe computers. Examples of handheld computers include personal digital assistants (PDAs) and notebooks. The network 150 may be any type of network familiar to those skilled in the art provided it can support data communications using any of a variety of commercially-available protocols, including without limitation TCP/IP and so on. Merely by way of example, the network 150 may be a local area network (LAN), such as an Ethernet network; a virtual network, including without limitation a virtual private network (VPN); the Internet; a wireless network; or any combination of these and other networks.

The storage device 120 can store a database for storing the number of software licenses, a full utilization rate and an average utilization rate of the software in a preset period, the number of employees who work overtime, the number of overtime hours, the amount of time spent using the software, and the cost related to the overtime in an overtime period during the preset period, wherein the preset period is one month or one year.

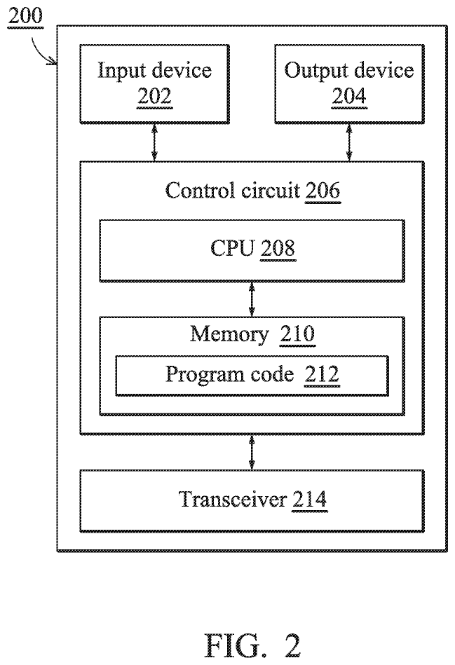

FIG. 2 shows an alternative simplified functional block diagram of a communication device 200 according to one embodiment of the present disclosure. As shown in FIG. 2, the communication device 200 can be utilized for realizing the electronic device 110 and the storage device 120 in FIG. 1. The communication device 200 may include an input device 202, an output device 204, a control circuit 206, a central processing unit (CPU) 208, a memory 210, a program code 212, and a transceiver 214. The control circuit 206 executes the program code 212 in the memory 210 through the CPU 208, thereby controlling the operation of the communication device 200. The communication device 200 can receive signals input by a user through the input device 202, such as a keyboard or keypad, and can output images and sounds through the output device 204, such as a monitor or speakers. The transceiver 214 is used to receive and transmit wireless signals wirelessly, deliver received signals to the control circuit 206, and output signals generated by the control circuit 206.

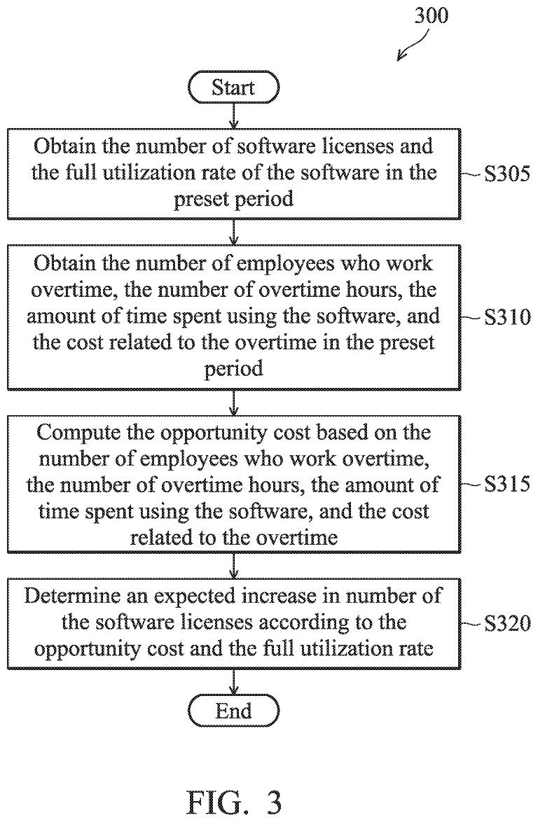

FIG. 3 is a flowchart 300 illustrating a method for determining the number of software licenses in accordance with an embodiment of the present disclosure. The method is used in an electronic device. In step S305, the electronic device obtains the number of software licenses and the full utilization rate of the software in the preset period from the storage device.

Then, in step S310, the electronic device obtains the number of employees who work overtime, the number of overtime hours, the amount of time spent using the software, and the cost related to the overtime in the preset period from the storage device. Furthermore, in step S315, the electronic device computes the opportunity cost based on the number of employees who work overtime, the number of overtime hours, the amount of time spent using the software, and the cost related to the overtime. In step S320, the electronic device determines an expected increase in number of the software licenses according to the opportunity cost and the full utilization rate.

The details of how the electronic device determines the expected increase in number of the software licenses according to the opportunity cost and the full utilization rate in FIG. 3 will be explained in the following.

The electronic device can obtain the number of software licenses, the full utilization rate and an average utilization rate of the software during a preset period from the storage device. The electronic device can derive the relationship between the expected increase in number of the software licenses and a target average utilization rate according to the number of software licenses, the full utilization rate and the average utilization rate. For example, it is assumed that in December 2018, the number of software licenses is 48, the full utilization rate is 35.03%, and the average utilization rate is 90.66%. The relationship between the expected increase in number of the software licenses x and a target average utilization rate t can be expressed by the following formula:

48×1×90.66%+x×35.03%<=(48+x)×1×t

wherein x can be expressed further as following:

x≥48×(90.66%−t)/(t−35.03%)

wherein it is assumed that when a user sets the target average utilization rate t=90%, the electronic device may compute the expected increase in number of the software licenses x≥0.58. It is assumed that when a user sets the target average utilization rate t=75%, the electronic device may compute the expected increase in number of the software licenses x≥18.81.

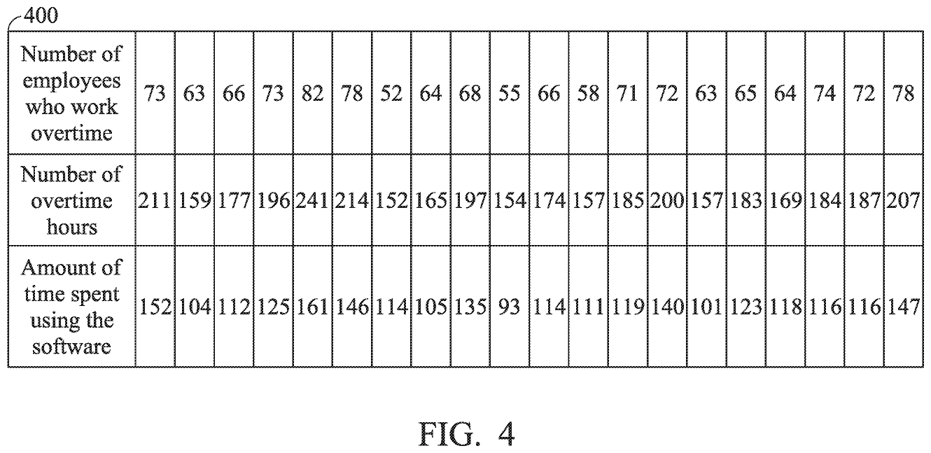

Next, the electronic device may obtain the number of employees who work overtime, the number of overtime hours, the amount of time spent using the software, and the cost related to the overtime during the overtime hours of the weekdays in December from the storage device. FIG. 4 is a table 400 illustrating the number of employees who work overtime, the number of overtime hours, the amount of time spent using the software on weekdays in December according to an embodiment of the present disclosure. It should be noted that although the table 400 only displays the data of December, the electronic device may obtain complete data of other months from the storage device, and thus the present invention is not limited to the embodiment shown in FIG. 4.

As shown in FIG. 4, in December, the number of employees who work overtime is significantly higher than the number of software licenses, 48. In other words, when some people who work overtime use the software, there may still be others waiting to use the software. Therefore, the waiting time is still the overtime hours. In FIG. 4, the number of overtime hours is defined as the hour when the people use the software. One overtime hour is counted even the use of software is less than one hour, and therefore the number of overtime hours will be higher than the total hours using the software.

Next, it is assumed that the calculation period is the total working hours minus off-peak time, 6 hours. The electronic device calculates that 6×35.03%=2.1 hours of authorization time can be provided for each software license purchased according to the full utilization rate, 35.03%.

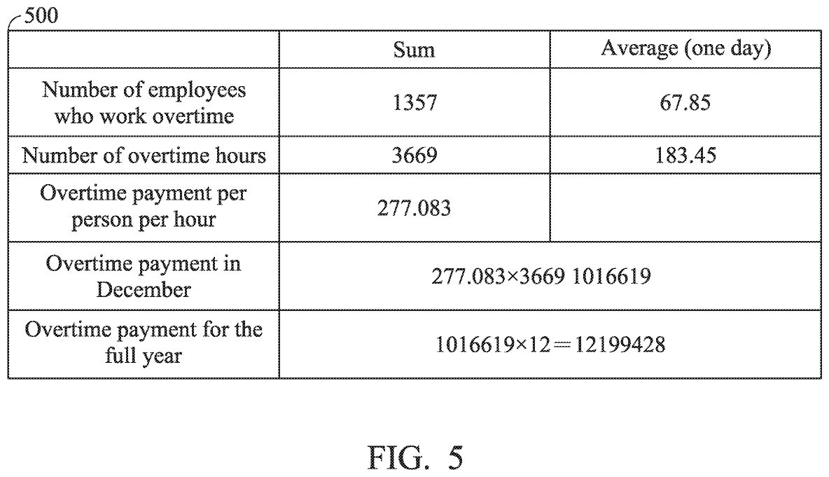

The electronic device can calculate the opportunity cost based on the number of employees who work overtime, the number of overtime hours, the amount of time spent using the software and the cost related to the overtime. FIG. 5 is a table 500 illustrating the opportunity cost in accordance with an embodiment of the present disclosure. It is assumed that the overtime payment per person per hour is $277.083, and the overtime payment in December is $1,016,619. The overtime payment for the full year can be estimated to be $12,199,425 according to the overtime payment in December.

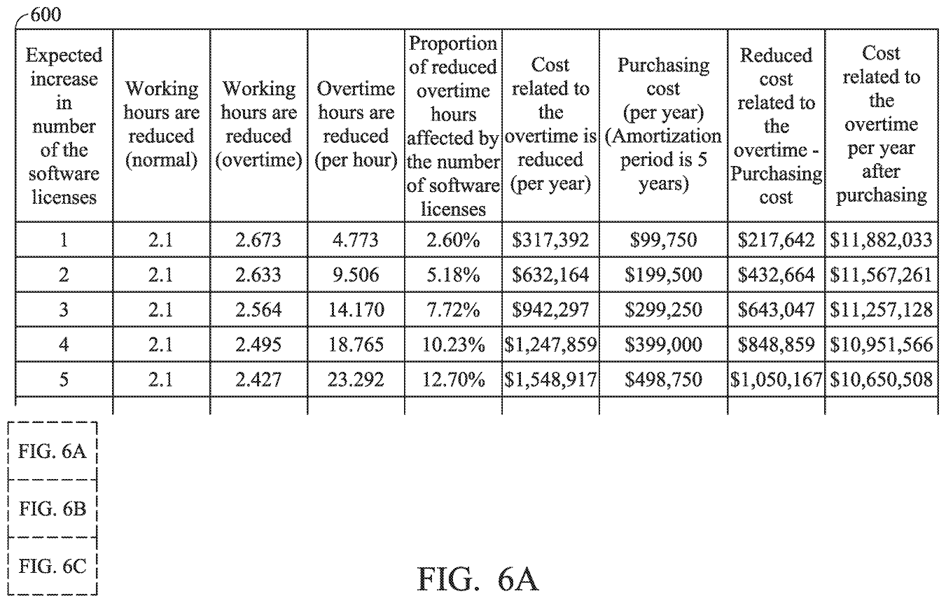

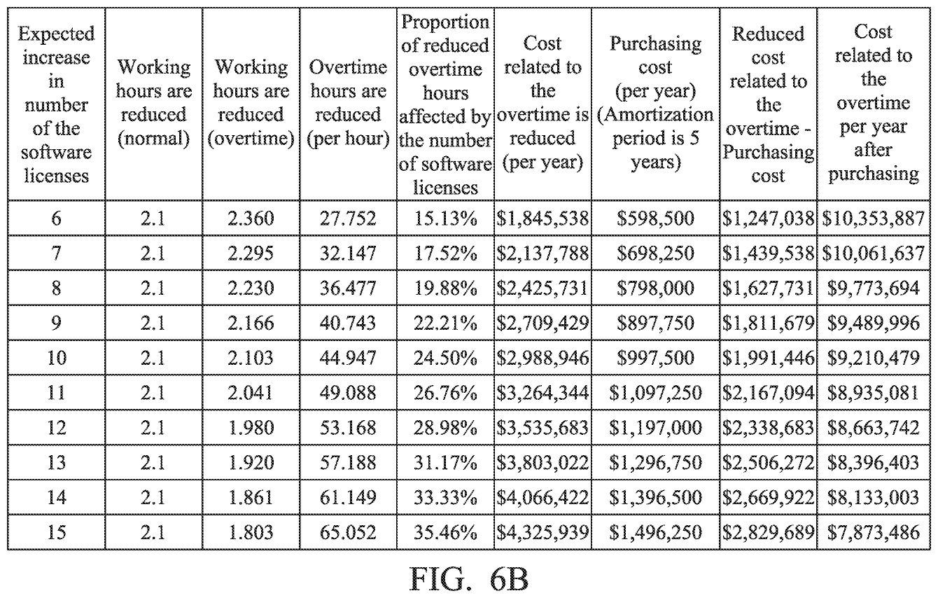

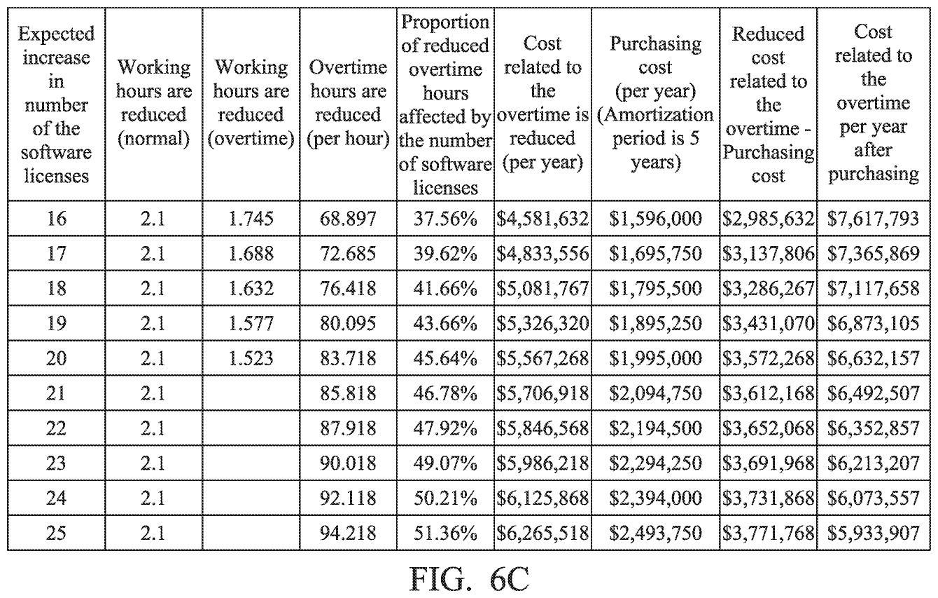

Next, the electronic device can obtain the authorization cost and an amortization period for the software from the storage device. It is assumed that the authorization cost of the software is $498,750 and the amortization period is 5 years. The electronic device determines the expected increase in number of the software according to the opportunity cost, the authorization cost, the amortization period and the full utilization rate. FIGS. 6A-6C illustrate an analysis table 600 of the number and cost of the software according to an embodiment of the present disclosure. As shown in Table 600, the savings from the cost related to the overtime will increase as the expected increase in number of the software licenses increases. However, starting with the 21st set of software, the goal of saving the number of overtime hours is not achieved because the expected increase has exceeded the total demand. Therefore, the user may use Table 600 as a criterion. For example, when the user wants the expected increase in number of the software licenses to affect the overtime percentage by less than 25%, the user can select 10 sets of software as the expected increase in number of the software licenses. When the user wants the expected increase in number of the software licenses to affect the overtime percentage by less than 45%, the user can select 20 sets of software as the expected increase in number of the software licenses.

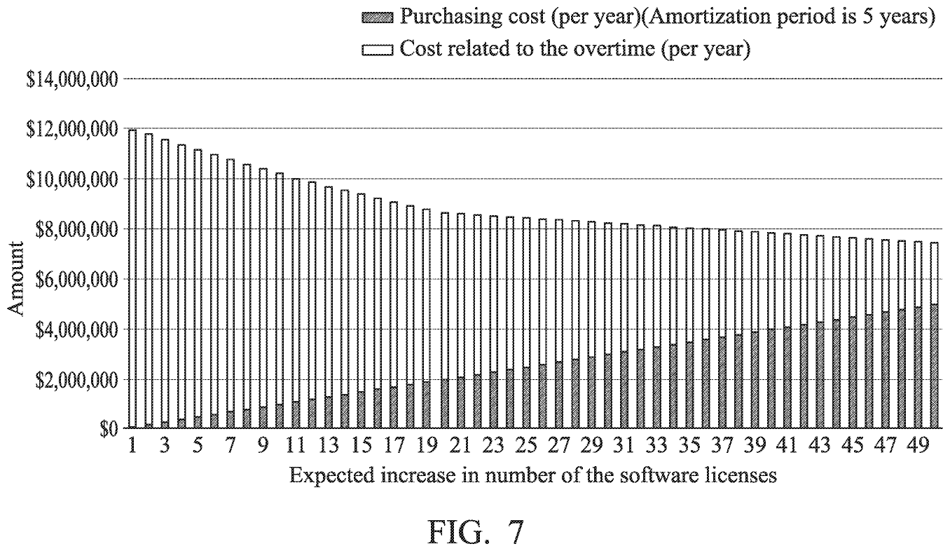

FIG. 7 is a diagram illustrating the purchasing cost of the software and the cost related to the overtime according to an embodiment of the present disclosure. As shown in FIG. 7, when the expected increase in number of the software licenses exceeds 20 sets of software, the savings will begin to slow down.

In another embodiment, the user may input an associated confidence index, and the electronic device can generate the best recommended number and cost-effectiveness under various associated confidence indices according to the associated confidence index.

Therefore, the method and device for determining the number of software licenses provided in the present disclosure can link the actual status of using the software to the opportunity cost to calculate the most reasonable and optimal expected increase in number of the software licenses.

In addition, the CPU 308 could execute the program code 312 to perform all of the above-described actions and steps or others described herein.

As shown above, the calibration parameters can be obtained according to paired information observed by selected pairs through the tree network topology formed by the selected node pairs in the disclosure. Since the environment parameters further are taken into consideration in the present disclosure, selecting inferior node pairs can be avoided and problems that cannot be solved by existing solutions can be solved. Furthermore, in addition to excellent performance, the suitable node pairs can still be found by using the calibration method and the wireless communication device for achieving the channel reciprocity proposed in the present disclosure even though the environment parameters change. The suitable node pairs may perform information exchange between the nodes to calculate the calibration parameters, so that interference from the downlink signal is minimized.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Those with skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in ways that vary for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or another programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It should be understood that any specific order or hierarchy of steps in any disclosed process is an example of a sample approach. It should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as random access memory (RAM), flash memory, read-only memory (ROM), erasable programmable read only memory (EPROM), electrically-erasable programmable read-only memory (EEPROM), registers, a hard disk, a removable disk, a compact disc read-only memory (CD-ROM), or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for determining a number of software licenses, used in an electronic device and comprising:
obtaining the number of software licenses and a full utilization rate of the software in a preset period;
obtaining a number of employees who work overtime, a number of overtime hours, amount of time spent using the software, and cost related to the overtime in the preset period;
computing opportunity cost based on the number of employees who work overtime, the number of overtime hours, the amount of time spent using the software and the cost related to the overtime; and
determining an expected increase in number of the software licenses according to the opportunity cost and the full utilization rate.

2. The method for determining the number of software licenses as claimed in claim 1, further comprising:
obtaining authorization cost and an amortization period for the software; and
determining the expected increase in number of the software licenses according to the opportunity cost, the authorization cost, the amortization period and the full utilization rate.

3. The method for determining the number of software licenses as claimed in claim 1, wherein the number of software licenses, the full utilization rate, the number of employees who work overtime, the number of overtime hours, the amount of time spent using the software, and the cost related to the overtime in the preset period are obtained from a storage device.

4. The method for determining the number of software licenses as claimed in claim 1, wherein the preset period is one month or one year.

5. A device for determining a number of software licenses, comprising:
a control circuit;
a processor installed in the control circuit; and
a memory installed in the control circuit and operatively coupled to the processor;
wherein the processor is configured to execute program codes stored in the memory to:
obtain the number of software licenses and a full utilization rate of the software in a preset period;
obtain a number of employees who work overtime, a number of overtime hours, amount of time spent using the software, and cost related to the overtime in the preset period;
compute opportunity cost based on the number of employees who work overtime, the number of overtime hours, the amount of time spent using the software and the cost related to the overtime; and
determine an expected increase in number of the software according to the opportunity cost and the full utilization rate.

6. The device for determining the number of software licenses as claimed in claim 5, wherein the processor further executes:
obtaining authorization cost and an amortization period for the software; and
determining the expected increase in number of the software licenses according to the opportunity cost, the authorization cost, the amortization period and the full utilization rate.

7. The device for determining the number of software licenses as claimed in claim 5 wherein the number of software licenses, the full utilization rate, the amount number of employees who work overtime, the number of overtime hours, the amount of time spent using the software, and the cost related to the overtime in the preset period are obtained from a storage device.

8. The device for determining the number of software licenses as claimed in claim 5, wherein the preset period is one month or one year.
